(19) United States
(12) Patent Application Publication
(10) Pub. No.: US 2010/0260014 A1
(43) Pub. Date: Oct. 14, 2010

(54) Watch Casing

(75) Inventors: Steven Avedis Der Bedrossian, New South Wales (AU); Sarkis Der Bedrossian, New South Wales (AU)

Correspondence Address: WOOD, HERRON & EVANS, LLP, 2700 CAREW TOWER, 441 VINE STREET, CINCINNATI, OH, 45202, US

(73) Assignee: SAMS WATCHMAKER JEWELLER PTY LTD, New South Wales (AU)

(21) Appl. No.: 12/756,365

(22) Filed: Apr. 8, 2010

(30) Foreign Application Priority Data
Apr. 8, 2009 (AU) 2009901535

(51) Int. Cl. G04B 37/00

(52) U.S. Cl. 368/276

(57) ABSTRACT

The present invention provides a watch casing (36) having a rear wall (20), the watch casing having a tubular passage (35) extending therethough through which an elongated material, such as a necklace or bracelet, can be inserted, wherein the passage (35) extends substantially across the rear wall (20). In one embodiment, the watch casing includes a rear casing (11) and a front casing (15) which together house the is components of a watch and the tubular passage is formed in the rear casing. The rear casing in the preferred embodiment comprises the rear wall (20) and a sidewall (21) extending from or adjacent to the periphery of the rear wall (20), the sidewall (21) including two openings (26) at substantially opposite portions thereof between which the tubular passage (35) extends.

### FIELD OF THE INVENTION

The present invention relates to a watch casing.

### BACKGROUND OF THE INVENTION

Bead jewellery consists of a base piece, such as a bracelet or a necklace, and a number of beads and charms added to the base piece. The beads and charms include an aperture through which the necklace or bracelet can be inserted through, with the bead or charm being movable therealong. Some beads are shaped as clips which can be clipped onto the bracelet or necklace at a fixed position thereon.

The beads and charms are typically of different shapes and colours, and are combined in any desired combination to suit a person's personal preference. One feature of a bead bracelet or necklace is that the clasp for connecting the two free ends of the necklace or a bracelet appears as a bead when closed, creating a seamless appearance to the bracelet or a necklace.

The present invention aims to provide a watch casing for a watch which will allow the watch to be used as a bead for such bracelets and necklaces.

### SUMMARY OF THE INVENTION

The present invention provides a watch casing having a rear wall, the watch casing having a passage extending therethough through which an elongated material can be inserted, wherein the passage extends substantially across said rear wall.

Preferably, the passage is tubular and extends between two openings in the casing.

In one embodiment, the watch casing includes a rear casing having the rear wall and a front casing, the rear casing and the front casing being for together housing the components of a watch, and wherein the passage is formed in the rear casing.

In an embodiment, the rear casing includes a sidewall extending from or adjacent to the periphery of the rear wall, the sidewall including two openings at substantially opposite portions thereof between which the tubular passage extends.

The sidewall is preferably circular and the openings are disposed at diametrically opposite portions thereof. The tubular passage is preferably formed by a tube extending between the openings.

In the preferred embodiment, the tubular passage extends through a mid-portion of the casing. In an alternative embodiment, the tubular passage extends through a lateral portion of the casing.

The present invention also provides a watch having a watch casing according to the above.

### BRIEF DESCRIPTION OF THE DRAWINGS

Preferred forms of the present invention will now be described by way of examples only with reference to the accompanying drawings wherein:

FIG. 1 is an exploded top perspective view of a first embodiment of the present invention;

FIG. 2 is an exploded bottom perspective view of a second embodiment of the present invention; and

FIG. 3 is an exploded top perspective view of the second embodiment of FIG. 2.

### DETAILED DESCRIPTION OF THE INVENTION

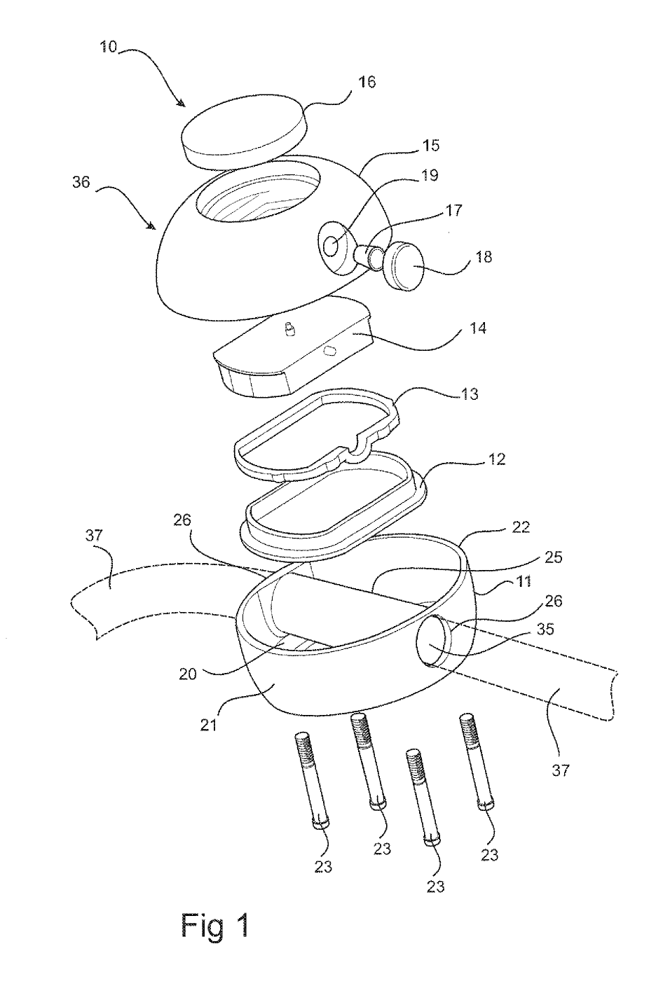

FIG. 1 shows an exploded perspective view of a first preferred embodiment of a watch 10 according to the present invention. The watch 10 includes a watch casing 36 comprising a rear casing 11 and a front casing 15, which together with a front face 16 house the typical components of a watch. The watch components include a backing plate 12 holding a movement holder 13 which then supports a movement mechanism 14. A connecting screw 17 and an adjustment crown 18 are connected to the movement mechanism 14 via a side aperture 19 in the front casing 15. The assembly of the watch 10 from the backing plate 12 to the front face 16 is similar to other watches for displaying time.

The rear casing 11 comprises a circular rear wall 20 and a circular sidewall 21 extending from the periphery of the rear wall 20. The sidewall 21 forms a rim 22. The rear wall 20 includes apertures (not shown) through which attachment screws 23 are inserted for attaching the front casing 15 to the rear casing 11. The sidewall 21 includes two openings 26 at diametrically opposite portions thereof, between which a tube 25 extends. Thus, the tube 25 extends through a central portion of the casing 36. When the front casing 15 is attached to the rear casing 11, the backing plate 12 sits against the tube 25 and is substantially aligned with the rim 22. Thus, unlike typical watches, the backing plate 12 is spaced from the rear wall 20.

The tube 25 and openings 26 form a tubular passage 35 which is dimensioned to allow an elongated material, such as a bracelet or necklace 37, to be inserted therethrough. Thus, when the watch 10 is assembled and added to a bracelet or necklace, the watch 10 is movable along the length of the bracelet or necklace 37.

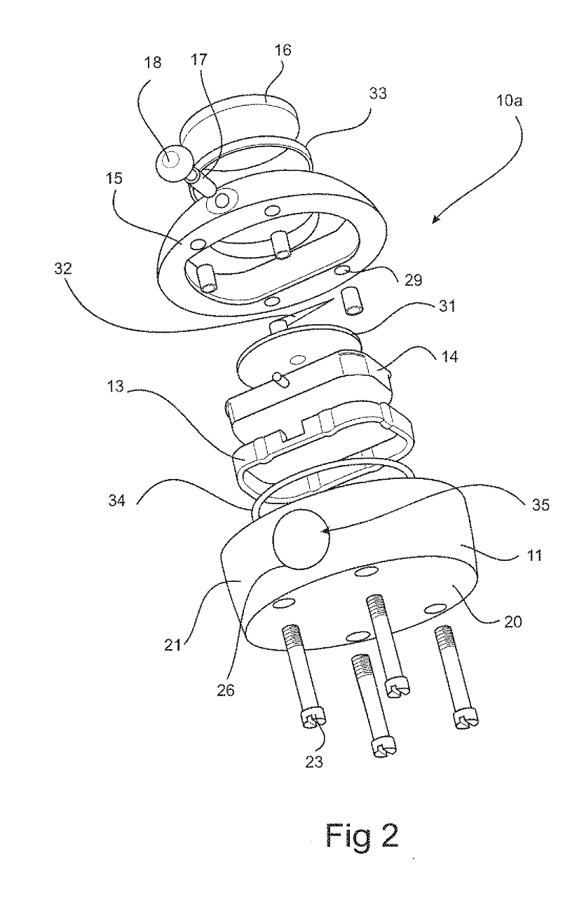

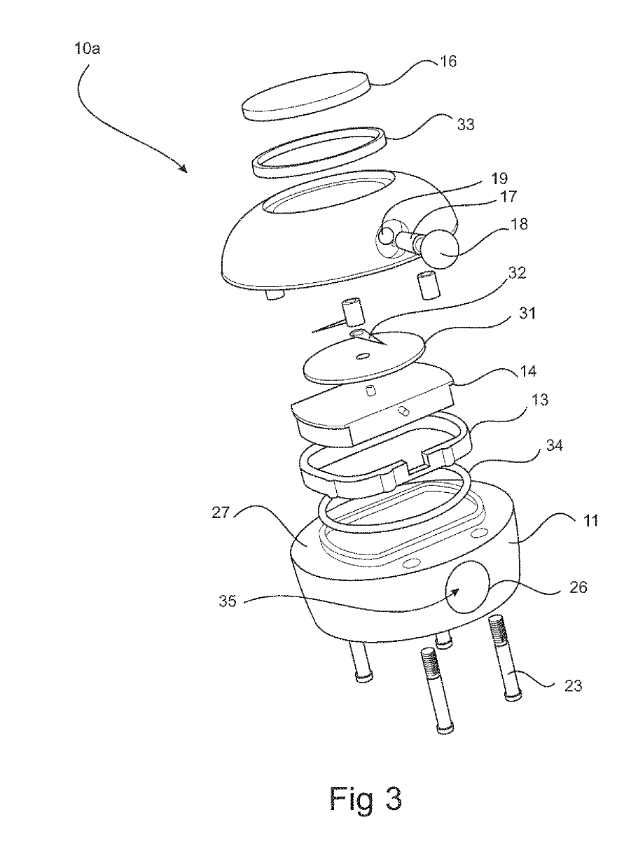

FIGS. 2 and 3 show a second embodiment of a watch 10a according to the present invention. The second embodiment 30 is essentially similar to the first embodiment and similar parts are numbered with similar reference numerals. The second embodiment 30 includes a dial 31 disposed on top of the movement mechanism 14 and watch hands 32 attached to the movement mechanism 14. This embodiment also includes an additional decorative ring 33 surrounding the transparent front face 16, and a sealing ring 34 between the front casing 15 and the rear casing 11.

The rear casing 11 in this embodiment is hollow and substantially closed in structure between its rear wall 20, a front wall 27 and the sidewall 21 extending therebetween. In this embodiment, the front wall 27 is soldered on to the sidewall 21. A tubular passage 35 having openings 26 extends through the rear casing 11 between diametrically opposite portions of the sidewall 21. The rear casing 11 also includes four spaced apertures 28 extending between the rear wall 20 and front wall 27 through which the attachment screws 23 are inserted for insertion into threaded holes 29 of the front casing 15.

As with the first embodiment, the tubular opening 26a is dimensioned to allow a bracelet or necklace to be inserted therethrough.

It can be seen that the present invention provides a watch casing for a watch which when assembled, can be added to a necklace or bracelet or other piece of elongated jewellery such as bead jewellery, which allows a person to decorate such jewellery as desired.

Although preferred embodiments of the invention have been described, it will be apparent to skilled persons that the present invention can be embodied in other forms. For example, the watch casing (front and rear casings) can be shaped as desired, such as square, rectangular or oval shaped and having the tubular passage extending between two sidewalls thereof. Also, the tubular passage can be located offset from a central portion of the watch casing if desired. In other possible embodiments, the watch movement mechanism 14 may be reconfigured to fit in the space between the sidewall 21 and the tube 25 in the first embodiment to have a lower profile watch.

A watch having the watch casing of the present invention can also be added to other elongated material apart from necklaces and bracelets, such as strings or cords, shoelaces and others.

In another possible embodiment, one or both openings 26 can be disposed in the s rear wall 20 or at the junction between the rear wall 20 and the sidewall 21. In this embodiment, the tubular passage 35 may be curved or include a curved portion. In another possible embodiment, the tubular passage can be replaced by a channel formed in the rear face of the rear casing. The channel can have one or more spaced bars extending across same which will be sufficient to retain a chain inserted therewithin.

The claims defining the invention are as follows:

1. A watch casing having a rear wall, the watch casing having a passage extending therethough through which an elongated material can be inserted, wherein the passage extends substantially across said rear wall.

2. The watch casing of claim 1 wherein the passage is tubular and extends between two openings in the casing.

3. The watch casing of claim 2 wherein the watch casing includes a rear casing having the rear wall and a front casing, the rear casing and the front casing being for together housing the components of a watch, and wherein the passage is formed in the rear casing.

4. The watch casing of claim 3, wherein the rear casing includes a sidewall extending from or adjacent to the periphery of the rear wall, the sidewall including two openings at substantially opposite portions thereof between which the tubular passage extends.

5. The watch casing of claim 4 wherein the sidewall is circular and the openings are disposed at diametrically opposite portions thereof.

6. The watch casing of claim 5 wherein the tubular passage is formed by a tube extending between the openings.

7. The watch casing of claim 1 wherein the tubular passage extends through a mid-portion of the casing.

8. The watch casing of claim 1 wherein the tubular passage extends through a lateral portion of the casing.

9. A watch having a watch casing according to claim 1.

10. A watch having a watch casing according to claim 5.
